(19) United States
(12) Patent Application Publication
(10) Pub. No.: US 2016/0075099 A1
(43) Pub. Date: Mar. 17, 2016

(54) MOLD STRUCTURE FOR PRESSING AND CUTTING PAPERBOARD

(71) Applicant: Shang-Ruei Wang, Taipei City (TW)

(72) Inventor: Shang-Ruei Wang, Taipei City (TW)

(21) Appl. No.: 14/485,561

(22) Filed: Sep. 12, 2014

(51) Int. Cl. B31D 5/00; B31F 1/00

(52) U.S. Cl. CPC B31D 5/0069; B31F 1/0035; B31D 5/0086; B31D 2205/0017; B31D 2205/0058

(57) ABSTRACT

The mold structure includes an upper mold, a pressing mold and a bottom mold. The upper mold has downward pressers and knives. The knives are interlaced with the pressers. Each of the knives is higher than adjacent one of the pressers. The pressing mold is flexibly connected under the upper mold and has through holes for being passed through by the pressers and knives. The bottom mold is arranged under the pressing mold and the upper mold for supporting a sheet of paperboard to be pressed and cut.

### BACKGROUND OF THE INVENTION

1. Technical Field

The invention relates to knife mold, particularly to a mold structure for pressing and cutting honeycombed paperboard.

2. Related Art

Commercial products must be packaged. Electronic products must be packaged with vibration reduction mechanism to prevent from damage in transportation.

Expandable polystyrene (EPS) is a common packaging material for vibration reduction. However, EPS is very hard to be discomposed under natural conditions and tends to cause pollution. To avoid environmental pollution, paperboard, such as corrugated paper or honeycombed paperboard, is used as vibration reduction packaging material.

Honeycombed paper possesses advantages of light weight, high strength and high rigidity and is a great packaging material with buffering, thermal isolation and sound isolation.

Honeycombed paperboard must be processed to fit shapes of products. Such a shaping process requires multiple treatments including pressing, adhesion and cutting. The conventional shaping process for honeycombed paperboard is uneconomical and the paperboard which is adhered by this process must reduce its structural strength. Furthermore, the honeycombed structure in the paperboard will be destroyed by repeatedly cutting. And the knife is easy to be jammed.

### SUMMARY OF THE INVENTION

An object of the invention is to provide a mold structure for pressing and cutting honeycombed paperboard, which can simultaneously press and cut honeycombed paperboard for shaping.

To accomplish the above object, the mold structure of the invention includes an upper mold, a pressing mold and a bottom mold. The upper mold has downward pressers and knives. The knives are interlaced with the pressers. Each of the knives is higher than adjacent one of the pressers. The pressing mold is flexibly connected under the upper mold and has through holes for being passed through by the pressers and knives. The bottom mold is arranged under the pressing mold and the upper mold for supporting a sheet of paperboard to be pressed and cut.

### BRIEF DESCRIPTION OF THE DRAWINGS

FIG. 1 is an exploded view of the invention;

FIG. 2 is an assembled view of the invention;

FIG. 3 is a schematic view of the invention and honeycombed paperboard;

FIG. 4 is a plan view of the knife of the invention;

FIGS. 5-7 show continuous statuses of the invention in use; and

FIG. 8 is a cross-sectional view of a piece of honeycombed paperboard which has been pressed and cut by the invention.

### DETAILED DESCRIPTION OF THE INVENTION

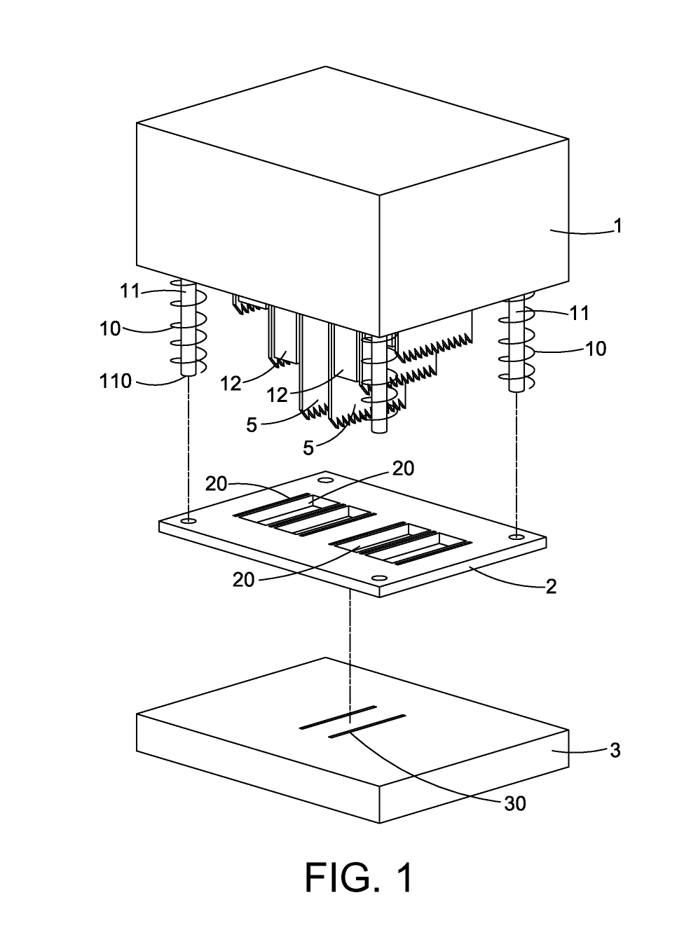

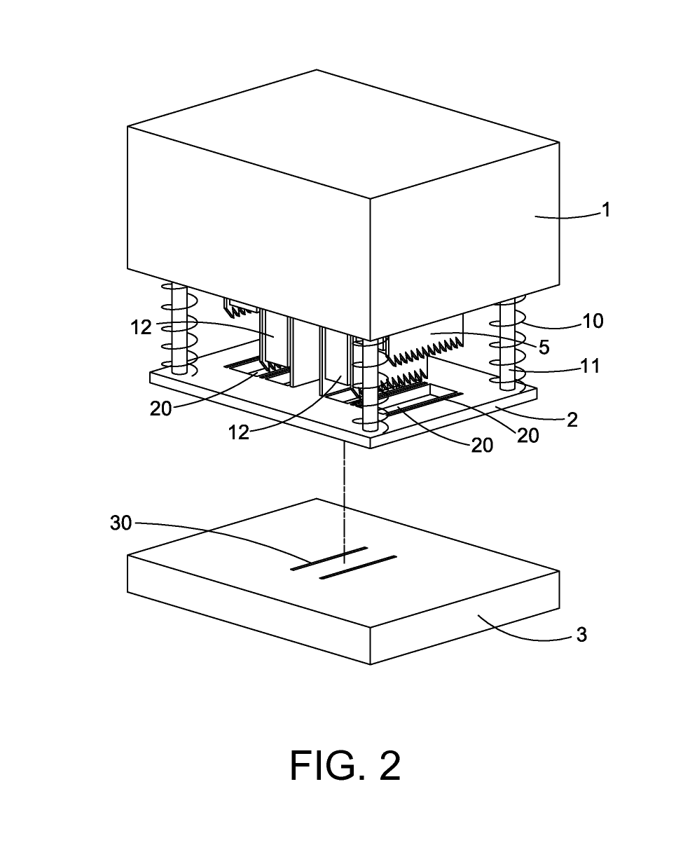

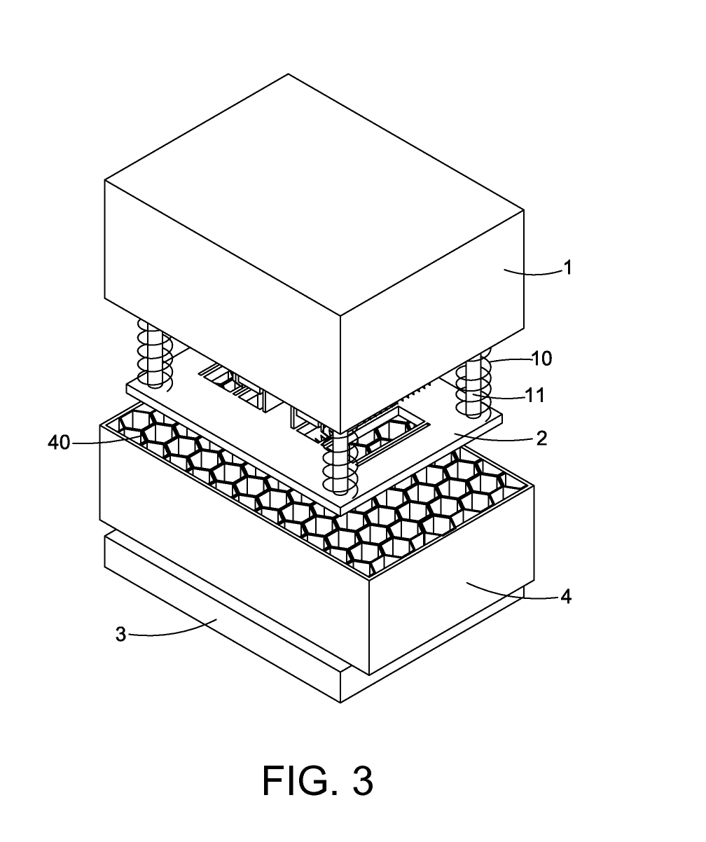

Please refer to FIGS. 1-3. The mold structure of the invention includes an upper mold 1, a pressing mold 2 and a bottom mold 3, which are vertically arranged. The pressing mold 2 is placed between the upper mold 1 and the bottom mold 3 and is flexibly connected to the upper mold 1 so that the upper mold 1 can flexibly move with respect to the pressing mold 2. The bottom mold 3 is used to support a piece of honeycombed paperboard 4 to be processed.

Multiple springs 10 are disposed between the upper mold 1 and the pressing mold 2 so that the upper mold 1 can flexibly move with respect to the pressing mold 2. Each spring 10 is axially passed by a rod 11. An outer end of the rod 10 is fastened to the pressing mold 2 and the other end thereof is fastened to the upper mold 1. The rods 11 make the upper mold 1 move stably.

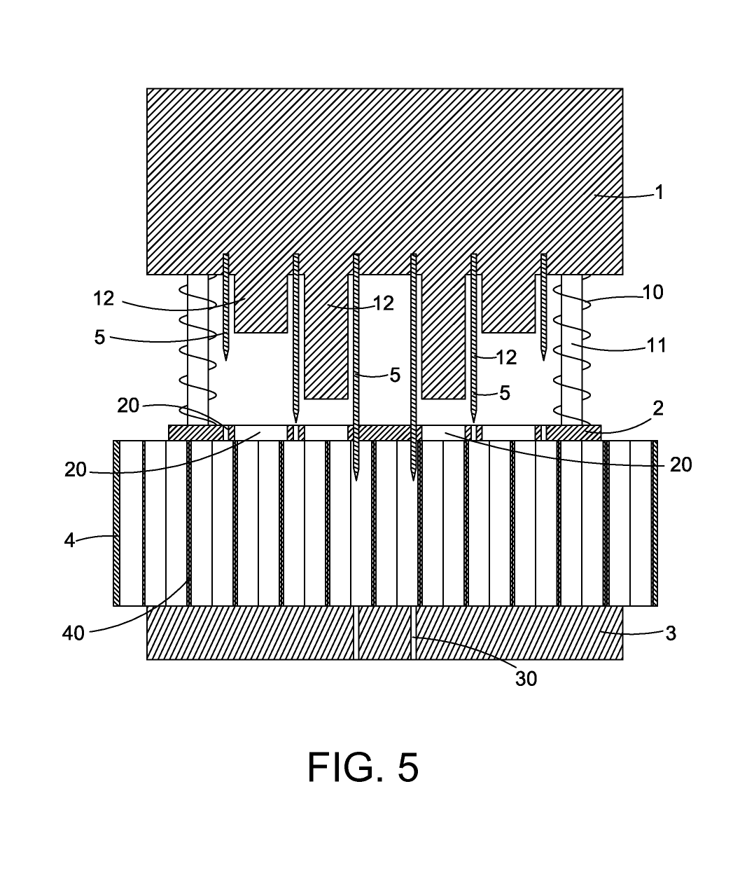

The upper mold 1 is provided with pressers 12 and knives 5 toward the pressing mold 2. As shown in FIG. 5, the pressers 12 may have different height to fit the shape to be formed. The knives 5 are interlaced with the pressers 12, and each of the knives 5 is higher than adjacent one of the pressers 12.

The pressing mold 2 is formed with through holes 20 for being passed through by the pressers and knives 5 so as to press and cut the honeycombed paperboard 4. The bottom mold 3 is formed with slots 30 for receiving the knives 5.

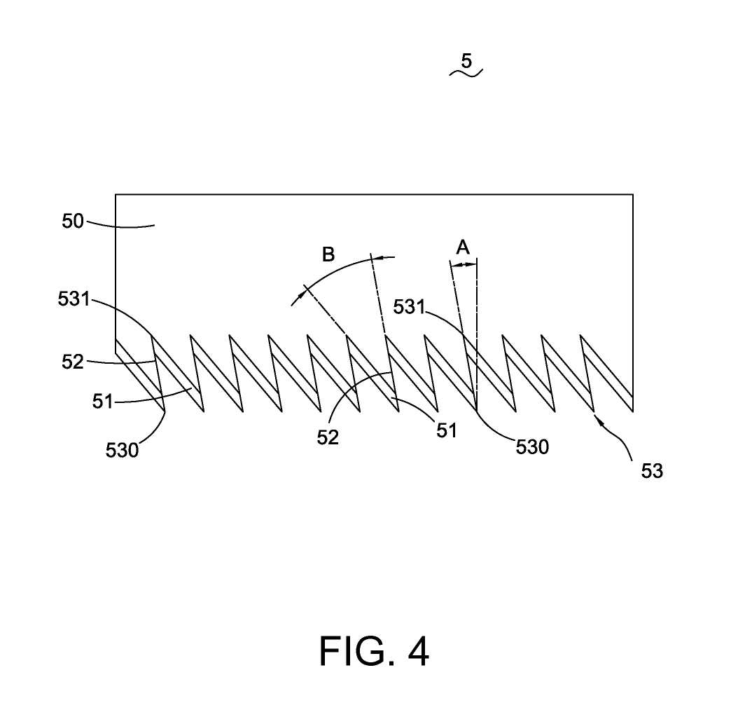

Please refer to FIG. 4. The knife 5 has a plate-shaped root portion 50 and a zigzag edge 53 extending therefrom. The zigzag edge 53 is composed of slant cutting edges 51 and spines 52. Each spine 52 and a vertical line form an angle A of about 10 degrees so that a tip 530 exceeds an adjacent valley 531. The angle B between the slant cutting edge 51 and the spine 52 is about 45 degrees.

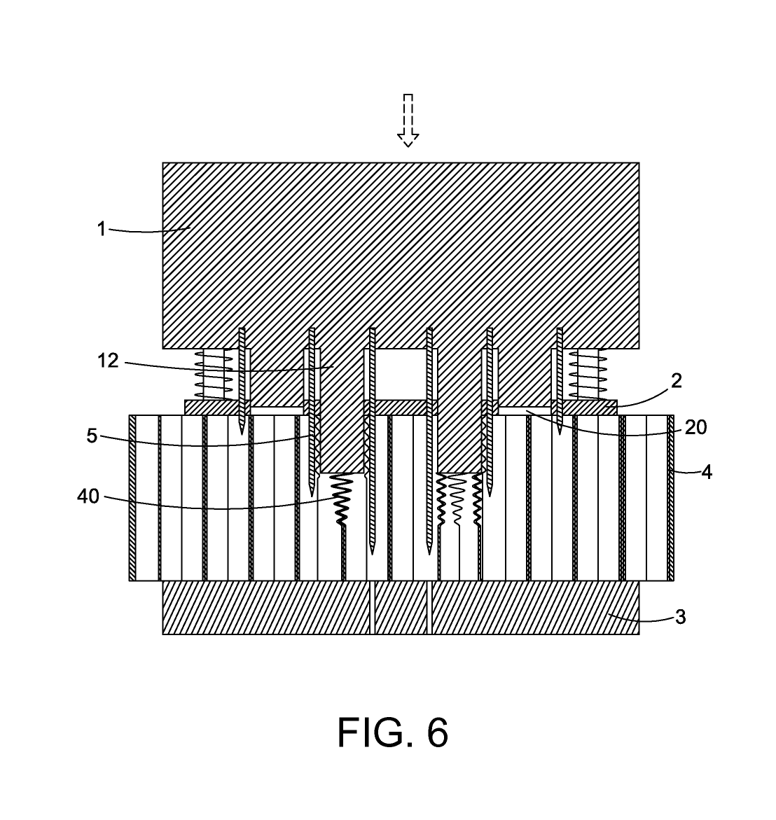

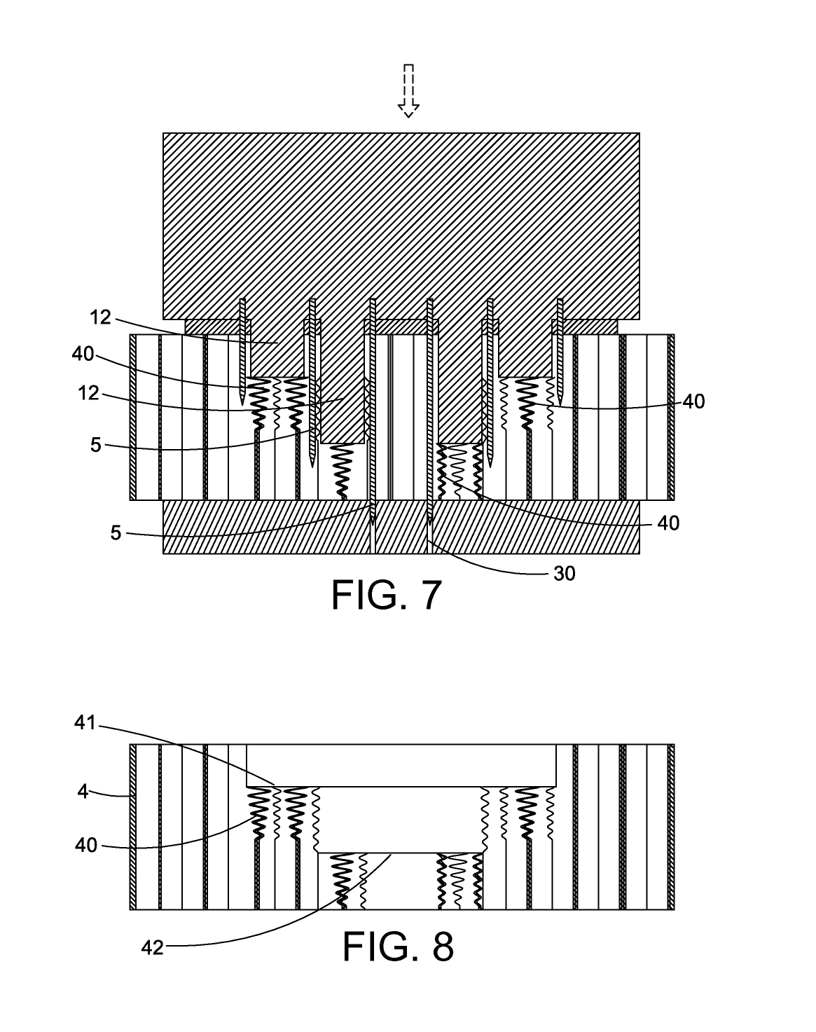

Please refer to FIG. 5. The honeycombed paperboard 4 is placed on the bottom mold 3 and is slightly pressed by the pressing mold 2. The pressers 12 and knives 5 are moved toward the pressing mold 2 when the upper mold 1 is pressed down. The knives 5 are higher than the pressers 12, so the knives 5 will pass the through holes 20 prior to the pressers 12. The zigzag edge 53 of the knives 5 will pierce the honeycombed paperboard 4. Please refer to FIGS. 6 and 7. When the upper mold 1 is further pressed down, the pressers 12 will easily destroy the paper core 40 because it has been pierced and cut. The different height of the pressers 12 will shape the paper core 40 to form cavities 41, 42 with different depth as shown in FIG. 8.

The zigzag edge 53 makes the knife 5 easy to pierce the honeycombed paperboard 4. When the knife 5 further pierces the paper core 40, the slant cutting edge 51 and the spine 52 will not be jammed by the paper core 40 because the tip 530 exceeds the valley 531. Thus the paper core 40 will be formed in a good shape.

What is claimed is:

1. A mold structure for paperboard, comprising:
an upper mold, having downward pressers and knives, the knives being interlaced with the pressers, wherein each of the knives is higher than adjacent one of the pressers;
a pressing mold, flexibly connected under the upper mold, having through holes for being passed through by the pressers and knives;
a bottom mold, arranged under the pressing mold and the upper mold for supporting a sheet of paperboard to be pressed and cut.

2. The mold structure of claim 1, wherein each of the knives has a plate-shaped root portion and a zigzag edge extending therefrom, the zigzag edge is composed of slant cutting edges and spines, and a tip of the zigzag edge exceeds an adjacent valley of the zigzag edge.

3. The mold structure of claim 2, wherein each spine and a vertical line form an angle of about 10 degrees.

4. The mold structure of claim 2, wherein an angle between the slant cutting edge and the spine is about 45 degrees.

5. The mold structure of claim 1, wherein multiple springs are disposed between the upper mold and the pressing mold, each spring is axially passed by a rod, two ends of the rod is separately fastened to the pressing mold and the upper mold 1.

6. The mold structure of claim 1, wherein the bottom mold is formed with slots for receiving the knives.
